(19) United States
(12) Patent Application Publication
(10) Pub. No.: US 2024/0391005 A1
(43) Pub. Date: Nov. 28, 2024

(54) METHOD FOR PRODUCING A MILLING TOOL, MILLING TOOL, AND METHOD FOR PRODUCING GEAR TEETH BY MILLING USING A MILLING TOOL OF THIS KIND

(71) Applicant: ADELBERT HAAS GMBH, Trossingen (DE)

(72) Inventor: Wolfram Josef HERMLE, Hausen ob Verena (DE)

(21) Appl. No.: 18/693,447

(22) PCT Filed: Sep. 20, 2021
(86) PCT No.: PCT/EP2021/075814

§ 371 Date: Mar. 19, 2024

(51) Int. Cl. B23F 5/20; B23F 21/12; B23P 15/34

(52) U.S. Cl. CPC B23F 5/202; B23F 21/122; B23P 15/34

(57) ABSTRACT

A method for producing a milling tool with cutting teeth includes the steps: defining a tooth profile to be machined with the milling tool from a workpiece to be processed to produce a gear tooth; determining a cutting tooth geometry, including the cutting edges of the cutting tooth geometry, with which the defined tooth profile to be machined in the workpiece to be processed can be machined using a milling process; subdividing the cutting tooth geometry into at least two different partial cutting tooth geometries, wherein the different partial cutting tooth geometries are configured such that at least one of the partial cutting tooth geometries has portions which recess behind the outer contour of the cutting tooth geometry and that the superposition of the different partial cutting tooth geometries reproduces the cutting tooth geometry; providing a milling tool blank; and machining of cutting teeth from the milling tool blank.

Milling processes, in particular gear hobbing processes and the gear skiving process known from DE 243514, play an important role in the machining production of gears. In this process, a milling tool having cutting teeth is used to machine a workpiece in a sequence of cutting operations, in which the cutting teeth generally remove a chip of the material of the workpiece blank, which machines interdental spaces in the workpiece blank, so that the gear teeth are produced. For a given processing geometry, the form of the cutting teeth of the milling tool, which is defined by the form of their cutting edges, hereinafter referred to as the cutting tooth geometry, is determined by the form of the interdental space to be machined in the workpiece blank.

In principle, chip formation in all milling processes influences the achievable precision and the surface quality of the produced gear teeth. Up to now, attempts have been made to optimize the precision and surface quality, in particular, by attempting to improve the cutting edges of the cutting teeth. For example, attempts have been made to use rounded cutting edges in order to minimize the consequences of uncontrolled forces acting on the cutting edge and to obtain tools with improved tool life. It has, however, been shown that this creates new problems, in particular with regard to the exact positioning of the cutting edge and the beginning of the chip removal by the engaging cutting edge. The surface finish becomes undefined due to a sliding of the cutting edge on the material to be machined and/or a “tearing” of the material; in addition, material changes occur due to the “tearing” and due to a bulging of the cutting edge on the material, resulting in undesirable heat input and friction losses.

Accordingly, the task of the invention is to provide a method for producing a milling tool, a milling tool, and a method for producing gear teeth by milling using a milling tool of this kind, which improves the gear tooth quality of gear teeth.

This task is solved by a method with the features of patent claim 1, by a milling tool with the features of patent claim 5, and by a method with the features of patent claim 7. Advantageous further developments of the invention are the subject of the respective dependent claims.

The method according to the invention for producing a milling tool with cutting teeth comprises, in particular, the steps already required so far,
Defining a tooth profile to be machined with the milling tool from a workpiece to be processed,
Determining a cutting tooth geometry including the cutting edges of the cutting tooth geometry, with which the defined tooth profile to be machined in the workpiece to be processed for the production of a gear tooth can be machined using a milling process,
Providing a tool blank, and
Machining of cutting teeth from the tool blank.

It is essential to the invention that the cutting tooth geometry is subdivided into at least two different partial cutting tooth geometries, wherein the different partial cutting tooth geometries are configured such that at least one of the partial cutting tooth geometries has portions which recess behind the outer contour of the cutting tooth geometry and that the superposition of the different partial cutting tooth geometries reproduces the cutting tooth geometry. Each of the partial cutting tooth geometries preferably has such portions.

Each portion of the cutting edges of the cutting tooth geometry that is required to machine a given interdental space is thus a component of at least one partial cutting tooth geometry, whereas conversely there is at least one partial cutting tooth geometry that does not have at least one of these portions. It is preferable if at least one portion of the cutting edges of the cutting tooth geometry is missing in each of the partial cutting tooth geometries.

The cutting edges of the identically formed cutting teeth of the milling tool according to the prior art, with which interdental spaces of the desired form are introduced into the workpiece, are thus distributed according to the invention over several cutting teeth, of which at least one, preferably a plurality, comprise further cutting edge portions in addition to the one or plurality of such cutting edge portions, but which lie within the cutting tooth geometry, the contour line of which is predetermined by the cutting edges.

When the cutting teeth are machined, cutting teeth having the different partial cutting tooth geometries are then machined in the milling tool blank.

There are therefore differently formed cutting teeth on the milling tool produced according to the invention, which cutting teeth are brought into engagement at least in portions one after the other during the processing of a workpiece with this milling tool during the production of a gear tooth for machining a tooth gap with the defined tooth profile from the workpiece, which engagement can be ensured, for example, by adjusting the ratio of the number of teeth of the tool and the gear teeth to be produced, and can thereby remove material by machining.

This can, in particular, lead to the fact that, at least in certain interactions of these cutting teeth with the workpiece, only a part of the already partially machined tooth profile of the interdental space to be machined is respectively further processed, which is to say, material is only removed there. In this case, there is at least one portion of a tooth flank of the interdental space that has already been partially machined in the workpiece, which has the tooth profile that remains unprocessed after completion.

One might intuitively assume that subdividing the cutting tooth geometry into partial cutting tooth geometries would extend the processing time. It, however, turns out that this is not the case to any significant extent. The processing speed is positively influenced by the fact that a reduction in the force required for processing on the one hand and an improvement of the flow properties of the chips on the other can be achieved by reducing the number of tooth flanks or the length of the tooth flank portions of the milling tool, which are simultaneously brought into interaction with the workpiece being processed by it.

At the same time, this approach can lead to a significant improvement in the processing quality, in particular with regard to tooth flank quality. According to the findings of the inventors, this can be ascribed to changes in the process of chip formation associated with this subdivision.

The improvement in the processing quality and in particular of the tooth flank quality is brought about by the fact that the subdivision of the cutting tooth geometry into partial cutting tooth geometries makes it possible to influence the engagement of the individual portions of the cutting edge as they enter the material and to control the chip thickness or alternatively its variation in different portions of the chip.

In order to arrive at reliable predictions that lead to optimized partial cutting tooth geometries, it is preferable if the method additionally comprises the step of calculating a theoretical material removal during the interaction of a cutting tooth with a given cutting tooth geometry and/or partial cutting tooth geometries with a workpiece.

In particular, in a milling tool manufactured according to the invention and in the milling tool according to the invention, it can be ensured that removed chips have a minimum thickness at every point by adapting the partial cutting tooth geometries in such a way that tooth flanks on which only a very delicate chip would need to be removed are exempted in (at least) one partial cutting tooth geometry and are thus skipped in the cutting processes that the cutting teeth perform with these partial cutting tooth geometries.

In practice, this can be done during subdivision of the cutting tooth geometry into the partial cutting tooth geometries, if those cutting flanks or those portions of cutting flanks of the cutting tooth geometry are exempted from a partial cutting tooth geometry for which the theoretical material removal falls below a specified limit value.

According to a further advantageous configuration of the method, the machining in the milling tool blank of the cutting teeth that comprise the different partial cutting tooth geometries is carried out using a grinding wheel with a standardized profile or standard grinding wheel, so that different cutting tooth profiles can be processed/produced with the same grinding wheel, and this preferably using end of the line processing. In contrast to the customary use of individually manufactured form-grinding wheels for each cutting tooth profile, this is more cost-effective and also allows the cutting teeth to be customized in a simple manner with different partial cutting tooth geometries.

The milling tool according to the invention for producing gear teeth in a workpiece to be processed by means of machining a tooth profile during the milling process is characterized in that the milling tool comprises cutting teeth with at least two different partial cutting tooth geometries, which geometries together form the cutting tooth geometry, including the cutting edges of the cutting tooth geometry, with which the specified tooth profile to be machined in the workpiece to be processed can be machined using the milling process, wherein the different partial cutting tooth geometries are configured in such a way that only a subset of the cutting edges of the cutting tooth geometry interacts with the workpiece to be processed during the interaction of at least one cutting tooth with one of the partial cutting tooth geometries with the workpiece to be processed.

It is particularly preferred if the different partial cutting tooth geometries are configured such that, when a cutting tooth with the respective partial cutting tooth geometries interacts with the workpiece to be processed, only a subset of the cutting edges of the cutting tooth geometry interacts with the workpiece to be processed.

The method according to the invention for producing a gear tooth in a workpiece to be processed by machining a tooth profile by milling using such a milling tool is characterized in that when sequentially machining a given gap between two teeth of the tooth profile, cutting teeth of the milling tool with different partial cutting tooth geometries are used one after the other. This can be achieved, in particular, by adjusting the number of teeth of the gear teeth and of the milling tool, if these are selected appropriately.

The invention is explained in more detail below with reference to figures showing embodiment examples. Wherein:

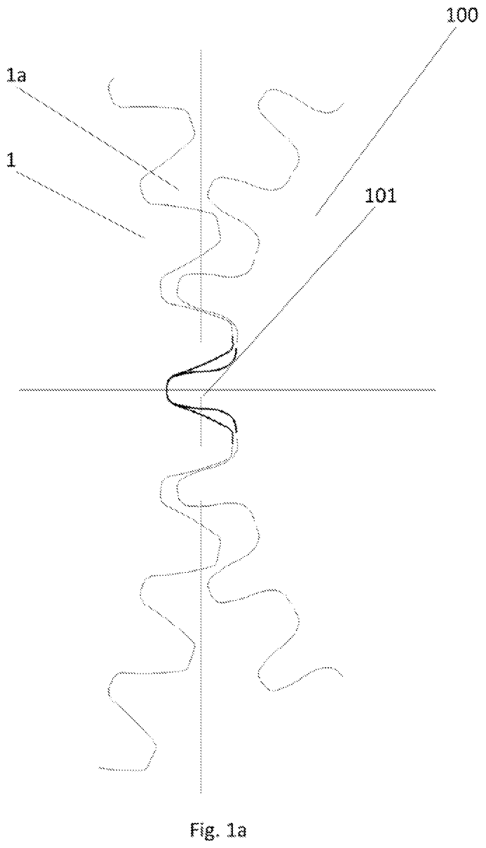

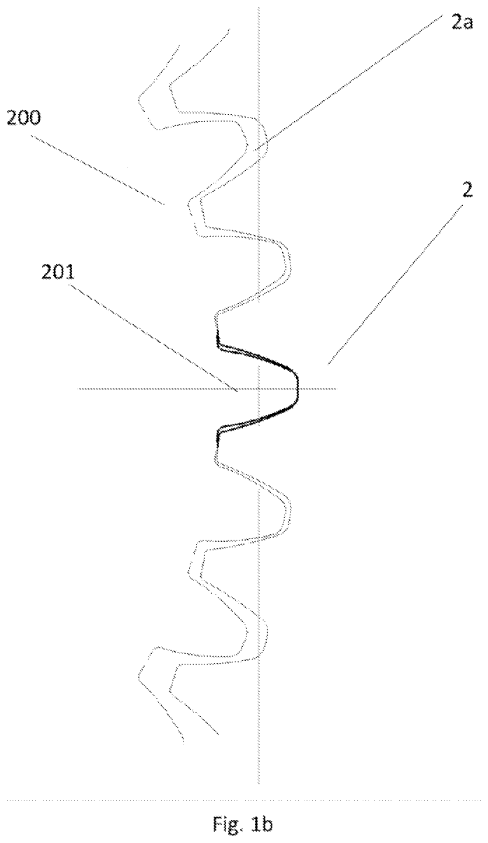

FIG. 1a: shows a workpiece with external gear teeth and a tool with a cutting tooth geometry with which these gear teeth can be introduced into the workpiece in a milling process;

FIG. 1b: shows a workpiece with internal gear teeth and a tool with a cutting tooth geometry with which these gear teeth can be introduced into the workpiece in a milling process;

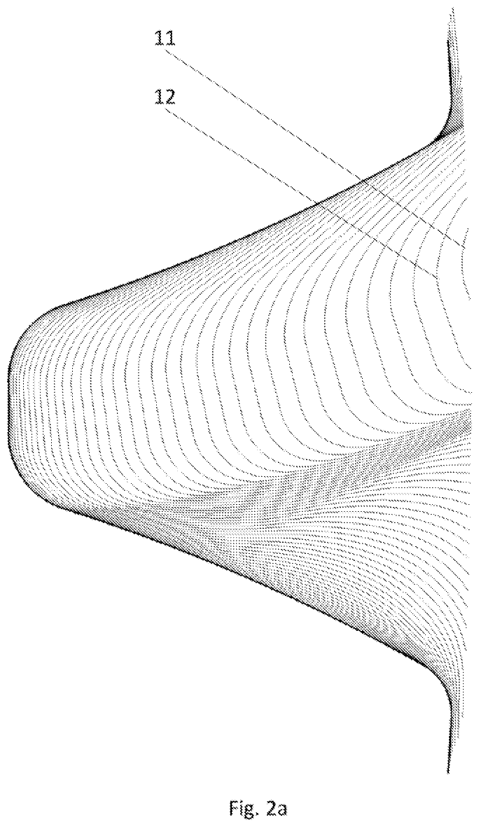

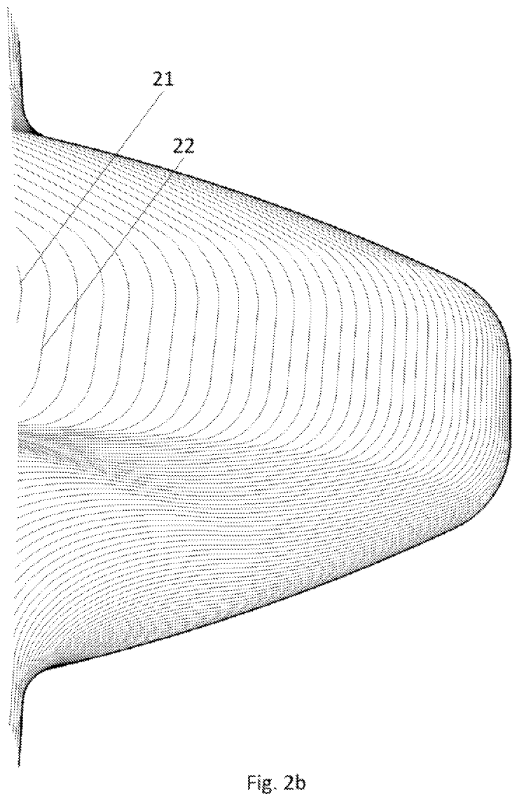

FIG. 2a: shows a sequence of intermediate states during the introduction of the gear teeth into the workpiece according to FIG. 1a using a milling tool with cutting teeth having the cutting tooth geometry according to FIG. 1a;

FIG. 2b: shows a sequence of intermediate states during the introduction of the gear teeth into the workpiece according to FIG. 1b using a milling tool with cutting teeth having the cutting tooth geometry according to FIG. 1b;

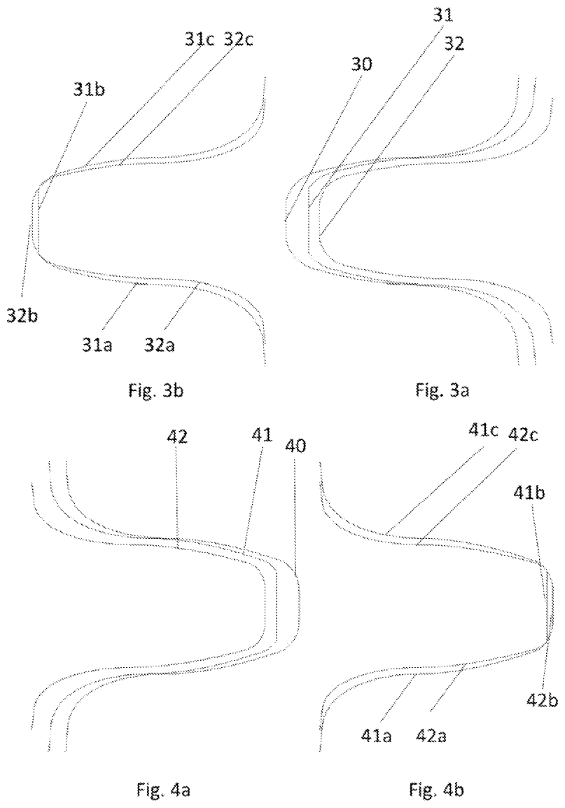

FIG. 3a: shows a representation of the cutting tooth geometry from FIG. 1a and a possibility for subdividing it into two partial cutting tooth geometries according to the invention;

FIG. 3b: shows a superimposed representation of the two partial cutting tooth geometries from FIG. 3a;

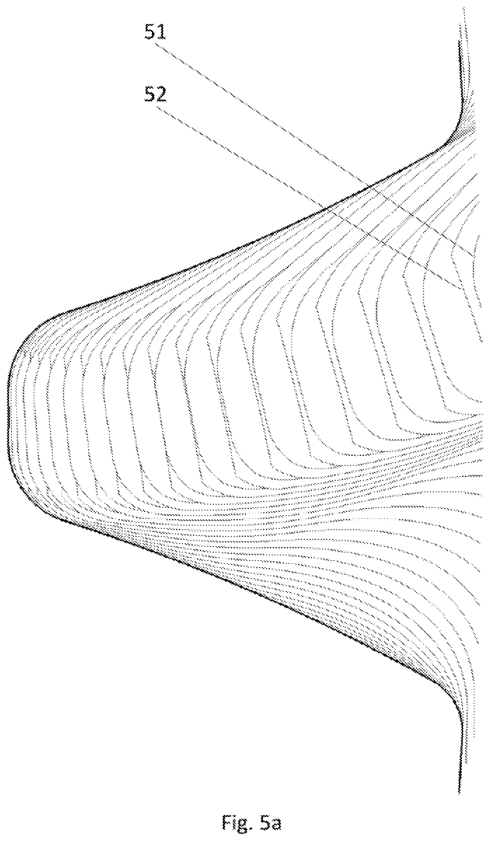

FIG. 4a: shows a representation of the cutting tooth geometry from FIG. 1b and a possibility for subdividing it into two partial cutting tooth geometries according to the invention;

FIG. 4b: shows a superimposed representation of the two partial cutting tooth geometries from FIG. 4a;

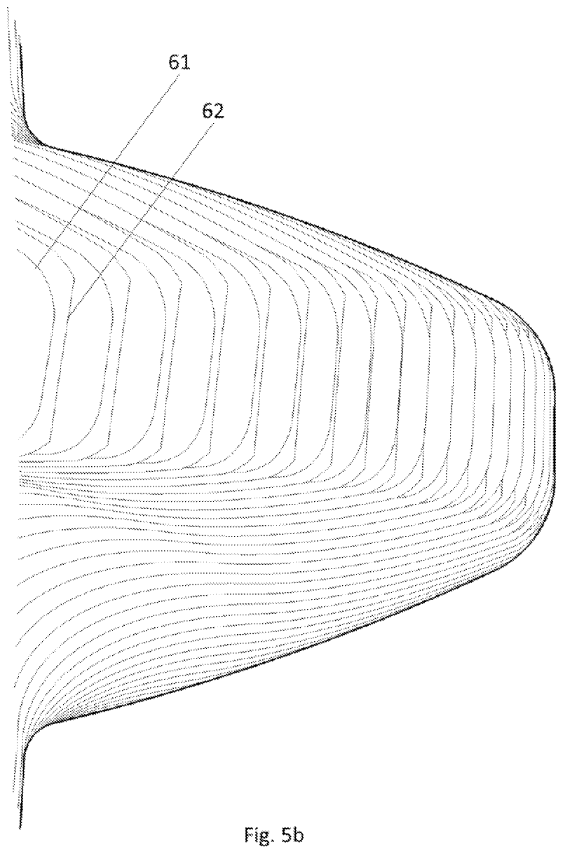

FIG. 5a: shows a sequence of intermediate states during the introduction of the outer gear teeth into the workpiece according to FIG. 1a with a milling tool with cutting teeth which, according to the invention, are introduced into the partial cutting tooth geometries according to FIG. 3b; and

FIG. 5b: shows a sequence of intermediate states during the introduction of the internal gear teeth into the workpiece according to FIG. 1b with a milling tool with cutting teeth, which according to the invention, are introduced into the partial cutting tooth geometries according to FIG. 4b.

FIG. 1a shows, on the left side, a workpiece 1 with outer gear teeth already completely introduced by machining tooth gaps 1a of workpiece 1, on the right side, a milling tool 100 with a plurality of identical cutting teeth 101, the cutting tooth geometry of which is determined by the contour line of their cutting edges. The fact that the cutting teeth 101 can be introduced into the tooth gap 1a of the workpiece 1, notwithstanding that the cutting teeth are significantly narrower than the tooth gap 1a, as can be clearly seen in FIG. 1, is a consequence of the milling tool 100 cycle on the workpiece 1, which is typical for milling processes, in which the tooth gap 1a is successively cut into the workpiece 1.

FIG. 1b shows on the right-hand side a workpiece 2 with an inner gear tooth already completely introduced by machining tooth gaps 2a of workpiece 2, and on the right-hand side a milling tool 200 with a plurality of identical cutting teeth 201, the cutting tooth geometry of which is determined by the contour line of their cutting edges. As can be seen when comparing FIG. 1a and FIG. 1b, the radius ratios of the inner geared teeth and the milling tool 2 are significantly more similar to each other than in the case of the outer geared teeth and milling tool 1, which means that the width of the cutting teeth 201 is significantly more similar to the width of the tooth gaps 2a.

FIG. 2a or alternatively FIG. 2b each show a sequence of intermediate states when introducing the gear teeth with a milling tool according to the state of the art into the workpiece from FIG. 1a or alternatively FIG. 1b, which milling tool only has cutting teeth with the cutting tooth geometry according to FIG. 1a or alternatively FIG. 1b. The illustrations are each considerably enlarged; in the simulation shown here, the creation of a tooth gap with a total depth of 4 mm is respectively shown, which creation is realized by a sequence of approximately 80 cuts.

In FIG. 2a, the tooth gap is cut out step-by-step from right to left, so that, after the first material-removing cut, the cutting line 11 forms part of the workpiece surface, after the second material-removing cut, the cutting line 12, and so on. In FIG. 2b, the tooth gap is cut out step-by-step from left to right, so that after the first material-removing cut, the cutting line 21 forms part of the workpiece surface, after the second material-removing cut, the cutting line 22 forms part of the workpiece surface, and so on.

Accordingly, the area between two adjacent cutting lines respectively represents the tooth resulting from the next cut leading towards the tooth base of the tooth gap in its “ideal form,” which is to say, without influencing the chip while it is being removed. Both in the case of the cutting out of the outer gear teeth shown in FIG. 2a as well as in the case of the cutting out of the inner gear teeth shown in FIG. 2b, it can be seen that there are a large number of cutting lines that are very close together. Accordingly, it can be seen directly from FIG. 2a and FIG. 2b that, when introducing the tooth gap with a milling tool as known from the prior art, a large number of chips are produced which have very fine portions and, on the one hand, are therefore easily deformed during removal and, on the other hand, are not removed in a defined manner, which leads to suboptimal chip formation and consequently to suboptimal gear tooth quality.

FIG. 3a and FIG. 3b show an example of a subdivision of the cutting tooth geometry 30 for machining the outer gear teeth into two partial cutting tool geometries 31, 32 in accordance with the invention. In this example, the corresponding milling tool has only cutting teeth the cutting edges of which each comprise one of these partial cutting tooth geometries 31, 32 and which are arranged in such a way that successive cuts are made with cutting teeth of different partial cutting tooth geometries; a subdivision into more partial cutting tooth geometries can of course also be undertaken if this proves to be useful and there may also be cutting teeth on the milling tool the cutting edges of which correspond to the cutting tooth geometry, since, as can be seen, in particular, in FIG. 2a and FIG. 2b, the first chips removed do not yet have the problem of fine chip portions.

Cutting tooth geometry 30, partial cutting tooth geometry 31, and partial cutting tooth geometry 32 are respectively shown in FIG. 3a, with a constant offset to each other. As can already be seen in this figure, the partial cutting tooth geometry 31 is created by shortening the cutting tooth geometry 30 at its tip, but comprises its flanks, whereas the partial cutting tooth geometry 32 reproduces the tip of the cutting tooth geometry 30, but is narrower in the flank area.

As can be seen in FIG. 3b, in which the partial cutting tooth geometries 31, 32 are shown superimposed on each other, the partial cutting tooth geometries 31 and 32 together reproduce the cutting tooth geometry 30, which corresponds to the outer contour of the superimposed partial cutting tooth geometries 31 and 32. The portions 31a and 31c of the partial cutting tooth geometries 31 form the flanks of the cutting tooth geometry 30 and the portion 32b of the partial cutting tooth geometries 32 forms the tip of the cutting tooth geometry 30.

Accordingly, conversely, the partial cutting tooth geometry 31 comprises the portion 31b, which recedes behind the cutting tooth geometry 30, and the partial cutting tooth geometry 32 comprises the portions 32a and 32c, in which they recede behind the cutting tooth geometry 30.

FIG. 4a and FIG. 4b show the respective analogous situation for the cutting tooth geometry 40, with which the inner gear teeth are introduced, and the associated partial cutting tooth geometries 41 and 42 with the portions 41a, 41b, 41c or alternatively 42a, 42b, 42c, which is why reference can be made in this respect to the description of FIG. 3a and FIG. 3b with respectively adapted reference signs.

It is, however, explicitly emphasized that a different subdivision of the cutting tooth geometry 30, 40 into two or more partial cutting tooth geometries 31, 32, 41, 42 is also possible and that one partial cutting tooth geometry does not necessarily need to reproduce the tip and a second partial cutting tooth geometry does not need to reproduce the flanks of the cutting tooth geometry.

The effect of this measure can be seen in FIG. 5a and FIG. 5b, in which, as in FIG. 2a and FIG. 2b, a sequence of intermediate states marked by cutting lines 51, 52, 61, 62 is shown during which the outer or alternatively inner gear teeth are introduced into the workpiece 1 or alternatively 2. In contrast to FIG. 2a and FIG. 2b, a milling tool is, however, now used, which respectively has different types of cutting teeth with the partial cutting tooth geometries 31, 32 or alternatively 41, 42, which in the example shown are arranged on the milling tool in such a way that cutting teeth with respectively the partial cutting tooth geometry 31 or alternatively 41 and cutting teeth with the partial cutting tooth geometries 32 and 42 are used alternately. The total depth of the gear teeth and the feed rate are identical to FIG. 2a or alternatively FIG. 2b.

It can be seen at first glance that the areas in which only very fine chips are removed have now been significantly reduced. A defined chip formation can now be expected in these areas, which leads to a significantly higher gear tooth quality.

### LIST OF REFERENCE SIGNS

1, 2 Workpiece
100, 200 Milling tool
101, 201 Cutting tooth
1a, 2a Tooth gap
11, 12, 21, 22,
51, 52, 61, 62 Cutting line
30, 40 Cutting tooth geometry
31, 32, 41, 42 Partial cutting tooth geometries
31a, 31b, 31c,
32a, 32b, 32c Portion of the partial cutting tooth geometry
41a, 41b, 41c,
42a, 42b, 42c Portion of the partial cutting tooth geometry

1. Method for producing a milling tool (100, 200) with cutting teeth (101, 201) with the steps
Defining a tooth profile to be machined with the milling tool (100, 200) from a workpiece (1, 2) to be processed to produce a gear tooth,
Determining a cutting tooth geometry (30, 40), including the cutting edges of the cutting tooth geometry (30, 40), with which the defined tooth profile to be machined in the workpiece (1, 2) to be processed can be machined using a milling process,
Subdividing the cutting tooth geometry (30, 40) into at least two different partial cutting tooth geometries (31, 32, 41, 42), wherein the different partial cutting tooth geometries (31, 32, 41, 42) are configured such that at least one of the partial cutting tooth geometries (31, 32, 41, 42) has portions (31b, 32a, 32c, 41 b, 42a, 42c) which recess behind the outer contour of the cutting tooth geometry (30, 40) and that the superposition of the different partial cutting tooth geometries (31, 32, 41, 42) reproduces the cutting tooth geometry (30, 40),
Providing a milling tool blank, and
Machining of cutting teeth (101, 201), which have the different partial cutting tooth geometries (31, 32, 41, 42), from the milling tool blank.

2. Method according to claim 1,
characterized in that the method additionally comprises the step of calculating a theoretical material removal during the interaction of a cutting tooth (101, 201) with a given cutting tooth geometry (30, 40) and/or partial cutting tooth geometries (31, 32, 41, 42) with a workpiece (1, 2).

3. Method according to claim 2,
characterized in that, when dividing the cutting tooth geometry (30, 40) into the partial cutting tooth geometries (31, 32, 41, 42), those sections of the cutting tooth geometry (30, 40) in at least one partial cutting tooth geometry (31, 32, 41, 42) recess behind the cutting tooth geometry for which the theoretical material removal falls below a predetermined limit value at least in some portions, but is greater than zero.

4. Method according to claim 1, characterized in that the machining of cutting teeth (101, 201), which comprise the different partial cutting tooth geometries (31, 32, 41, 42), are machined from the milling tool blank using a grinding wheel with a standardized profile or standard grinding wheel, preferably using end of the line processing.

5. Milling tool (100, 200) for producing a gear tooth in a workpiece (1, 2) to be processed by means of machining a tooth profile using a milling process, characterized in that the milling tool (100, 200) comprises cutting teeth (101, 201) with at least two different partial cutting tooth geometries (31, 32, 41, 42), which geometries together form the cutting tooth geometry (30, 40) including the cutting edges of the cutting tooth geometry (30, 40), with which the specified tooth profile to be machined in the workpiece (1, 2) to be processed can be machined using the milling process, wherein the different partial cutting tool geometries (31, 32, 41, 42) are configured in such a way that only a subset of the cutting edges of the cutting tooth geometry (30, 40) interacts with the workpiece (1, 2) to be processed during the interaction of at least one cutting tooth (101, 201) with one of the partial cutting tooth geometries (31, 32, 41, 42) with the workpiece (1, 2) to be processed.

6. Milling tool according to claim 5,
characterized in that the different partial cutting tooth geometries (31, 32, 41, 42) are configured in such a way that only a subset of the cutting edges of the cutting tooth geometry (30, 40) interacts with the workpiece (1, 2) to be processed during the interaction of one cutting tooth (101, 201) with the respective partial cutting tooth geometry (31, 32, 41, 42) with the workpiece (1, 2) to be processed.

7. Method for producing a gear tooth in a workpiece (1, 2) to be processed by machining a tooth profile by milling using a milling tool (100, 200) according to claim 6,
characterized in that, when sequentially machining a given gap between two teeth of the tooth profile, cutting teeth (101, 201) of the milling tool (100, 200) with different partial cutting tooth geometries (31, 32, 41, 42) are used one after the other.

8. Method according to claim 2,
characterized in that the machining of cutting teeth (101, 201), which comprise the different partial cutting tooth geometries (31, 32, 41, 42), are machined from the milling tool blank using a grinding wheel with a standardized profile or standard grinding wheel, preferably using end of the line processing.

9. Method according to claim 3,
characterized in that the machining of cutting teeth (101, 201), which comprise the different partial cutting tooth geometries (31, 32, 41, 42), are machined from the milling tool blank using a grinding wheel with a standardized profile or standard grinding wheel, preferably using end of the line processing.
